(19) United States
(12) Patent Application Publication
(10) Pub. No.: US 2016/0086133 A1
(43) Pub. Date: Mar. 24, 2016

(54) SYSTEM AND METHOD FOR OPTIMIZING SOFTWARE MAINTENANCE DELIVERY CHARACTERISTICS USING CLIENT PORTFOLIO CHARACTERISTICS

(71) Applicant: Infosys Limited, Bangalore (IN)

(72) Inventors: Doddavarapu Venkateswara Surya Srikanth, Bangalore (IN); Virendra Paliwal, Bangalore (IN); Gopichand Agnihotram, Guntur (IN)

(21) Appl. No.: 14/829,033

(22) Filed: Aug. 18, 2015

(30) Foreign Application Priority Data
Sep. 22, 2014 (IN) 4592/CHE/2014

(51) Int. Cl. G06Q 10/10

(52) U.S. Cl. CPC G06Q 10/103

(57) ABSTRACT

The technique relates to a system and method for optimizing software maintenance delivery characteristics using client portfolio characteristics. The method involves obtaining a plurality of project maintenance characteristics and client portfolio characteristics from a software maintenance project repository, thereafter assigning a rating to each of the project maintenance characteristics and the client portfolio characteristics based on one or more assessment guidelines and finally building a relationship model between the project maintenance characteristics and the client portfolio characteristics by using one or more regression models wherein the relationship model uses an average of the assigned ratings of each of the project maintenance characteristics and the client portfolio characteristics. The method further involves validating the relationship model to determine a strength of the relationship model.

This application claims the benefit of Indian Patent Application Serial No. 4592/CHE/2014 filed Sep. 22, 2014, which is hereby incorporated by reference in its entirety.

### FIELD OF INVENTION

The present invention generally relates to optimizing software maintenance delivery characteristics, and in particular, to a system and method for optimizing software maintenance delivery characteristics using client portfolio characteristics.

### BACKGROUND

In various scenarios, the measurement/prediction of a company's performance is essential in order to formulate effective business management strategies. The optimization of software maintenance delivery characteristics are activities required to support the software system post-delivery in order to ensure that the software system is usable and meet the business needs on an ongoing basis. The optimization of software maintenance delivery characteristics play a vital role in determining the company's performance. Sometimes minimal information is available to arrive at an optimal set of project delivery characteristics such as Onsite full time employees (FTEs), Offshore FTEs, FTEs by roles by Managers, Leads, Developers etc, in such cases prediction becomes difficult. An effective strategy to determine optimal set of project delivery characteristics helps to identify improvement opportunities and create a plan to move the maintenance projects to deliver at the desired optimal level. For service companies, it is very common to be required to respond to a prospective client through the Request for Proposal (RFP) with a business management strategy. In case of application maintenance RFPs, prediction of the project delivery characteristics (For instance: Onsite full time employees (FTEs), Offshore FTEs, FTEs by roles by Managers, Leads, Developers etc,) based on client portfolio characteristics helps to improve a win-ratio while bidding, re-bidding for application maintenance deals.

### SUMMARY

The present invention overcomes the above mentioned limitations by providing a system and method for optimizing software maintenance delivery characteristics using client portfolio characteristics.

According to the present embodiment, a method for optimizing software maintenance delivery characteristics using client portfolio characteristics is disclosed. The method involves obtaining a plurality of project maintenance characteristics and client portfolio characteristics from a software maintenance project repository, thereafter assigning a rating to each of the project maintenance characteristics and the client portfolio characteristics based on one or more assessment guidelines then building a relationship model between the project maintenance characteristics and the client portfolio characteristics by using one or more regression models wherein the relationship model uses an average of the assigned ratings of each of the project maintenance characteristics and the client portfolio characteristics and finally determining an optimal set of project delivery characteristics based on the built relationship model by using one or more optimization techniques.

In an additional embodiment, a system for optimizing software maintenance delivery characteristics using client portfolio characteristics is disclosed. The system comprises one or more processors and one or more memories operatively coupled to at least one of the one or more processors and having instructions stored thereon that, when executed by at least one of the one or more processors, cause at least one of the one or more processors. The one or more processor obtain a plurality of project maintenance characteristics and client portfolio characteristics from a software maintenance project repository. Then assign a rating to each of the project maintenance characteristics and the client portfolio characteristics based on a one or more assessment guidelines. Thereafter, build a relationship model between the project maintenance characteristics and the client portfolio characteristics by using one or more regression models wherein the relationship model uses an average of the assigned ratings of each of the project maintenance characteristics and the client portfolio characteristics. And finally, determine an optimal set of project delivery characteristics based on the built relationship model by using one or more optimization techniques.

In another embodiment at least one non-transitory computer-readable medium storing computer-readable instructions that, when executed by one or more computing devices for optimizing software maintenance delivery characteristics using client portfolio characteristics is disclosed. This involves the at least one non-transitory computer-readable medium having stored thereon instructions for obtaining a plurality of project maintenance characteristics and client portfolio characteristics from a software maintenance project repository, thereafter assigning a rating to each of the project maintenance characteristics and the client portfolio characteristics based on one or more assessment guidelines then building a relationship model between the project maintenance characteristics and the client portfolio characteristics by using one or more regression models wherein the relationship model uses an average of the assigned ratings of each of the project maintenance characteristics and the client portfolio characteristics and finally determining an optimal set of project delivery characteristics based on the built relationship model by using one or more optimization techniques.

### BRIEF DESCRIPTION OF THE DRAWINGS

Various embodiments of the invention will, hereinafter, be described in conjunction with the appended drawings provided to illustrate, and not to limit the invention, wherein like designations denote like elements, and in which:

FIG. 1 is a computer architecture diagram illustrating a computing system capable of implementing the embodiments presented herein.

FIG. 2 is a flowchart, illustrating a method for optimizing software maintenance delivery characteristics, in accordance with an embodiment of the present invention.

FIG. 3 is a block diagram illustrating a system for optimizing software maintenance delivery characteristics, in accordance with an embodiment of the present invention.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

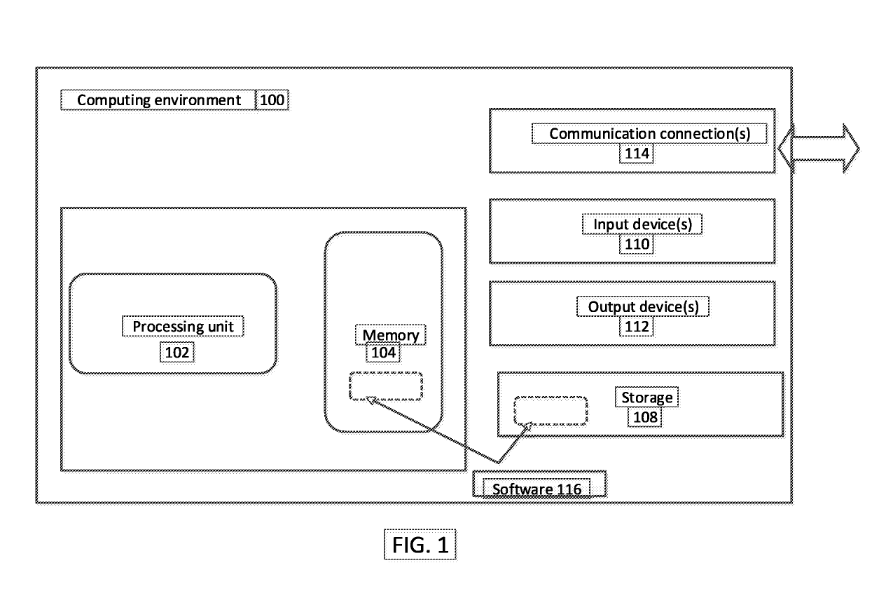

FIG. 1 illustrates a generalized example of a suitable computing environment 100 in which all embodiments, techniques, and technologies of this invention may be implemented. The computing environment 100 is not intended to suggest any limitation as to scope of use or functionality of the technology, as the technology may be implemented in diverse general-purpose or special-purpose computing environments. For example, the disclosed technology may be implemented using a computing device (e.g., a server, desktop, laptop, hand-held device, mobile device, PDA, etc.) comprising a processing unit, memory, and storage storing computer-executable instructions implementing the service level management technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like.

With reference to FIG. 1, the computing environment 100 includes at least one central processing unit 102 and memory 104. The central processing unit 102 executes computer-executable instructions. In a multi-processing system, multiple processing units execute computer-executable instructions to increase processing power and as such, multiple processors can be running simultaneously. The memory 104 may be volatile memory (e.g., registers, cache, RAM), non-volatile memory (e.g., ROM, EEPROM, flash memory, etc.), or some combination of the two. The memory 104 stores software 116 that can implement the technologies described herein. A computing environment may have additional features. For example, the computing environment 100 includes storage 108, one or more input devices 110, one or more output devices 112, and one or more communication connections 114. An interconnection mechanism (not shown) such as a bus, a controller, or a network, interconnects the components of the computing environment 100. Typically, operating system software (not shown) provides an operating environment for other software executing in the computing environment 100, and coordinates activities of the components of the computing environment 100.

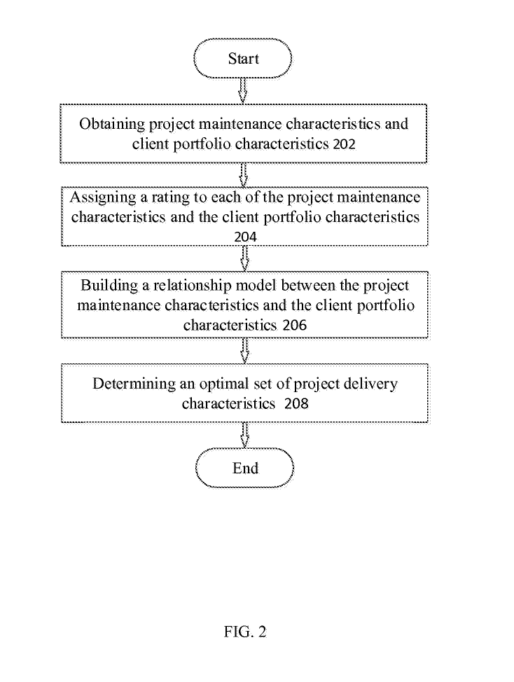

FIG. 2 is a flowchart, illustrating a method for optimizing software maintenance delivery characteristics, in accordance with an embodiment of the present invention. The software maintenance delivery characteristics are various activities required to support the software system post-delivery in order to ensure that the software system is usable and meet the business needs on an ongoing basis. The various kinds of activities are:

Corrective maintenance—to fix bugs, errors found after software delivery.

Adaptive maintenance—to keep the system updated based on changing business, technology needs.

Perfective maintenance—to improve overall performance and usability of a system.

Preventive maintenance—proactive steps taken to prevent issues from occurring in production.

The method involves obtaining a plurality of project maintenance characteristics and client portfolio characteristics from a software maintenance project repository at step 202. The project maintenance characteristics represents plurality of key parameters on how the maintenance project is delivered/executed by a service provider. This involves the total resources required to maintain the project, the location of these resources (onsite—client location; offshore—service provider location) and the resource mix in terms of the number of managers, high experience resources(analyst/leads) and low-medium experience resources(Engineers) etc. The Client Portfolio characteristics represents characteristics of a client's Information technology (T) systems under maintenance, which helps to understand the system better. These parameters determine an extent of resources required to maintain the IT systems. The client portfolio characteristics includes application characteristics, service characteristics, maintainability characteristics or combination thereof. The various client portfolio characteristics considered (but not limited to) are the technical complexity, business complexity, criticality, process maturity, support coverage, SLAs etc. After obtaining a plurality of project maintenance characteristics and client portfolio characteristics from a software maintenance project repository at step 202, a ratings are assigned to each of the project maintenance characteristics and the client portfolio characteristics based on one or more assessment guidelines at step 204. The rating is a qualitative rating obtained by various means. According to an exemplary embodiment of the invention, ratings are obtained from plurality of employees by means of a questionnaire and/or survey through an interface. The rating is assigned to raw data which comprises of project maintenance characteristics and client maintenance characteristics stored in a software project repository. The rating format and roll up of the data is as per the analysis model guidelines. The average of each rating is taken to build the relationship model. The assessment guidelines are rules which help to rate the project delivery characteristics and the client portfolio characteristics. This helps to bring a consistency in the ratings and convert them to a uniform scale as the project and client portfolio characteristics are a mix of qualitative and quantitative types. The ratings are measured based on a scale. The ratings are assigned based on the scale. For example, if the level of documentation for a project is qualitatively captured as “Low” then it can be assigned a value of 1 as per the rule set in the assessment guidelines. Likewise if level of documentation for a project is qualitatively captured as “High” then it can be assigned a value of 5 as per the assessment guidelines. After obtaining a plurality of project maintenance characteristics and client portfolio characteristics from a software maintenance project repository 202, and assigned ratings for each of the project maintenance characteristics and the client portfolio characteristics based on one or more assessment guidelines 204, a relationship model is built between the project maintenance characteristics and the client portfolio characteristics by using one or more regression models wherein the relationship model uses an average of the assigned ratings of each of the project maintenance characteristics and the client portfolio characteristics at step 206. The relationship models are built by one or more regression model which are multinomial logistic regression model, multiple regression model, or ordinal logistics regression model. The relationship model represents a relationship between a set of independent variables and a dependent variable. The changes to the values of independent variables have an impact on the value of the dependent variable. After obtaining a plurality of project maintenance characteristics and client portfolio characteristics from a software maintenance project repository 202, assigned ratings for each of the project maintenance characteristics and the client portfolio characteristics based on one or more assessment guidelines 204 and the relationship model, an optimal set of project delivery characteristics are determined based on the relationship model by using one or more optimization techniques at step 208. The optimal set of delivery characteristics are optimal values for project delivery characteristics like, Onsite full time employees (FTEs), Offshore FTEs, FTEs by roles by Managers, Leads, Developers etc. This is the set of values given by the model based on the client portfolio characteristics of the project. The optimal set of project delivery characteristics are determined based on the built relationship model by using one or more optimization techniques wherein the one or more optimization techniques comprise of linear techniques or nonlinear techniques or heuristics techniques. The one or more regression models are multinomial logistic regression model, multiple regression model, or ordinal logistics regression model.

According to another embodiment of the invention, the software repository updates automatically as and when optimal set of delivery characteristics are determined and obtained.

According to an exemplary embodiment of the invention, the plurality of project maintenance characteristics are:
GDM Ratio—Onsite: Offshore
Role Ratio—PM:PA:SE (PA=TL&TA; SE=SE&SSE)
Productivity

Wherein, GDM=Global delivery model
PM=Project Manager
PA=Project Analyst
TL=Technology lead
SE=Software Engineer
TA=Technology Analyst
SSE=Senior software engineer

Few other project parameters of interest
Project Type—T&M, FP, NEM
Tools Adoption Index
Age of association

Where,
T & M=Time & Material
FP=Fixed Price
NEM=New Engagement Models

The client portfolio characteristics considered were
Technical Complexity
Domain Complexity
Criticality
Technology Diversity
Client Process Maturity
Knowledge Management(Documentation availability)
Time zone overlap
SLA requirements
Support coverage

Here an association is predicted between the project delivery characteristic “productivity” and the client portfolio characteristics as given below.

Let the different variables used in the model be as below and an ordinal logistic regression model are fit on these variables since these variables are qualitative in 1-5 scale.
Y₁=Productivity
X₁=Documentation availability
X₂=New Joinee induction time
X₃=Age of association
X₄=Client processing maturity
X₅=Tool Index
X₆=Technical Complexity
X₇=Business Complexity
X₈=PA: SE Rating
X₉=Release frequency
Wherein,

The documentation availability is current state of a project related documentation and an accessibility of same.

The new Joinee induction time is approximate time taken for a fresh engineer and/or employee to be on boarded with the necessary knowledge before taking on the project related work.

The age of association is a number of years of association of a project team with a client.

The Client process maturity is a level of process maturity of a client IT organization.

The tool Index is an extent of tools used across various lifecycle stages in the project.

The technical Complexity is a complexity of an application portfolio in terms of the technologies used, number of interfaces, integration architecture etc.

The business complexity is a complexity of the application portfolio from a business domain, business process, workflows, business rules etc.

The PA: SE Rating is a ratio of plurality of experienced resources compared to less experienced and fresh engineers in the team which is also used to assess the overall experience level of the team.

The release frequency is a frequency with which the application related changes are moved into production.

The productivity improvement is a productivity is measure of a functionality developed in a project to a level of effort required to accomplish it. The productivity improvement is an indicator of how teams have improved on this number over the last 1 year through adoption of various tools, techniques and best practices.
1. Each variable have 5 states which are very Low, Low, Medium, High, and Very High.
2. The functional dependencies on each variable are as given below.

$${Y}_{1} = f ( {X}_{1} , {X}_{2} , {X}_{3} , {X}_{4} , {X}_{5} , {X}_{6} , {X}_{7} , {X}_{8} , {X}_{9} ) ;$$

$${p}_{j}^{( c )} = \frac{exp ( {u}_{j} )}{1 + exp ( {u}_{j} )}$$

$$Where$$

$$j = 1 , 2 , 3 , 4$$

$${u}_{j} = {{α}^{⋒}}_{j} + {\sum }_{i = 1}^{9} {\hat{β}}_{i} {X}_{i} ;$$

$$j = 1 , 2 , 3 , 4$$

$${p}_{1} = {p}_{1}^{( c )}$$

$${p}_{2} = {p}_{2}^{( c )} - {p}_{1}^{( c )}$$

$${p}_{3} = {p}_{3}^{( c )} - {p}_{2}^{( c )}$$

$${p}_{4} = {p}_{4}^{( c )} - {p}_{3}^{( c )}$$

$${p}_{5} = 1 - ( {p}_{1} + {p}_{2} + {p}_{3} + {p}_{4} )$$

$$or$$

$${p}_{5} = 1 - ( {\sum }_{i = 1}^{4} {p}_{i} )$$

$${p}_{i} = P ( {Y}_{1} = i \vert {X}_{1} , {X}_{2} , {X}_{3} , … , {X}_{8} , {X}_{9} ) ;$$

$$For i = 1 , 2 , 3 , 4$$

After determining the relationship such as linear or non-linear, the optimal set of project characteristics is obtained by using optimization technique such as linear or non-linear techniques based on the association type.

From above for each value of i=1,2,3,4 and the input variables X₁, X₂, X₃, . . . , X₈, X₉ takes the values from ,2,3,4,5 in different combinations.

For example:

If the relation is linear: For two input variables such as X₁, X₂ and for i=1, the different combinations for the two input variables are (X₁, X₂)=((1,1),(1,2),(1,3),(1,4),(1,5),(2,1),(2,2),(2,3),(2,4),(2,5),(3,1),(3,2),(3,3),(3,4),(3,5),(4,1),(4,2),(4,4),(4,5),(5,1),(5,2),(5,3),(5,4),(5,5)). Choose the combination where p₁ is maximum.

Hence simple linear optimization problem has been formulated such as maximize pᵢ for each i subject to different combination of discrete input variables Xᵢ, j=1,2, . . . , 9 which takes the values<=1,2,3,4,5.

In a case wherein functional dependencies are nonlinear such as f(X₁, X₂, X₃, X₄, X₅, X₆, X₇, X₈, X₉) is non-linear function then a nonlinear optimization problems has been formulated and optimization problems have been solved using nonlinear optimization techniques or any heuristics such as Genetic programing or simulation methods.

The method further involves validating the relationship model to determine a strength of the model by excluding a few random records from input and comparing actual values with predicted values.

According to an exemplary embodiment of the invention, for a sample of 63 maintenance projects for which data is received from an online survey and which had valid data, the following were the results of the analysis. The actual values were compared against the predicted values to verify the strength of the model.

| | Total | | |
|---|---|---|---|
| | Number of | Exact match | Exact match +/−1 |
| Type of analysis | records | (Act vs Pred) | (Act vs Pred) |
| Considered all valid records | 63 | 23(36%) | 47(74%) |
| Considered all valid records | 48 | 17(35%) | 33(69%) |
| and for projects having | | | |
| greater than 5FTEs | | | |
| Model fitted considering | 10 | 3(30%) | 5(50%) |
| 80% records and predicted | | | |
| for remaining 20% | | | |
| Model fitted considering | 48 | 20(42%) | 34(71%) |
| 80% records and predicted | | | |
| for filtered records (>5FTE) | | | |

For the data set under consideration and from the analysis of the model outputs it is observed that there exists a moderate association between project characteristic productivity and the client portfolio variables. The model was able to produce an exact match in 30-40% of cases and a near exact match (+/−1 variance) in 60-70% cases.

After determining the relationship, the optimal set of project characteristics is obtained by using optimization technique such as linear or non-linear optimization techniques based on the association type.

Likewise the association can be built for other project characteristics like onsite offshore ratio and role ratio etc.

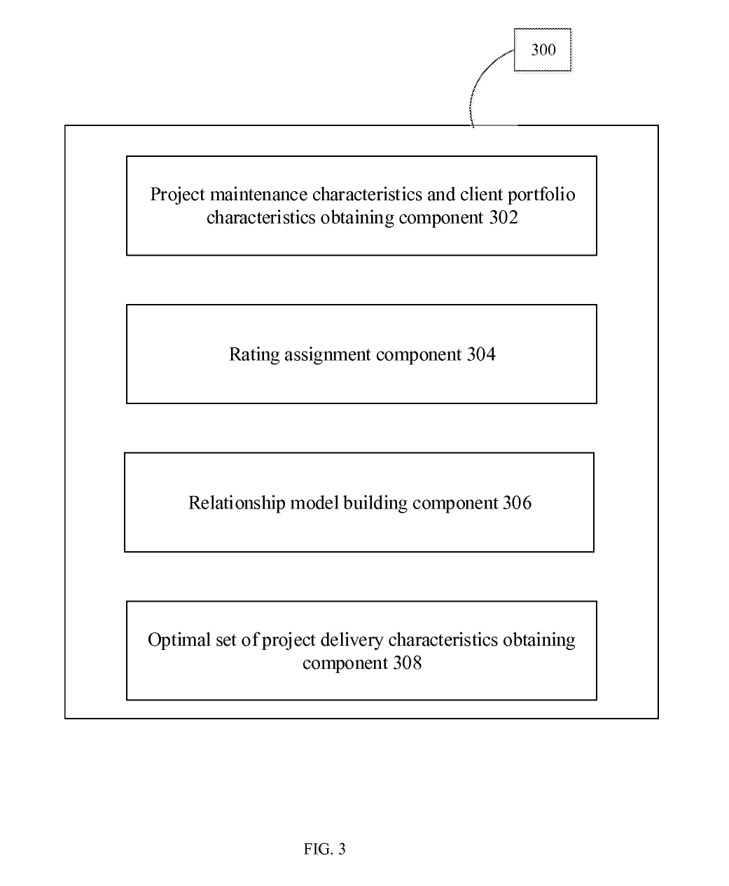

FIG. 3 is a block diagram illustrating a system for optimizing software maintenance delivery characteristics 300, in accordance with an embodiment of the present Invention. The system includes a project maintenance characteristics and client portfolio characteristics obtaining component 302, a rating assignment component 304, a relationship model building component 306 and an optimal set of project delivery characteristics obtaining component 308. The components reside in the memory at 104. The project maintenance characteristics and client portfolio characteristics obtaining component is configured to obtain a plurality of project maintenance characteristics and client portfolio characteristics from a software maintenance project repository. The rating assignment component configured to assign a rating to each of the project maintenance characteristics and the client portfolio characteristics based on a one or more assessment guidelines. The relationship model building component is configured to build a relationship model between the project maintenance characteristics and the client portfolio characteristics by using one or more regression models wherein the relationship model uses an average of the assigned ratings of each of the project maintenance characteristics and the client portfolio characteristics. The relationship models are built by one or more regression model which are multinomial logistic regression model, multiple regression model, or ordinal logistics regression model. The optimal set of project delivery characteristics obtaining component 308 is configured to obtain an optimal set of project delivery characteristics based on the relationship model by using one or more optimization techniques.

The above mentioned description is presented to enable a person of ordinary skill in the art to make and use the invention and is provided in the context of the requirement for obtaining a patent. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

What is claimed is:

1. A method for optimizing software maintenance delivery characteristics comprising:
obtaining, by a project maintenance computing device, a plurality of project maintenance characteristics and client portfolio characteristics from a software maintenance project repository;
assigning, by the project maintenance computing device, a rating to each of the project maintenance characteristics and the client portfolio characteristics based on one or more assessment guidelines;
building, by the project maintenance computing device, a relationship model between the project maintenance characteristics and the client portfolio characteristics by using one or more regression models wherein the relationship model uses an average of the assigned ratings of each of the project maintenance characteristics and the client portfolio characteristics; and
determining, by the project maintenance computing device, an optimal set of project delivery characteristics based on the built relationship model by using one or more optimization techniques.

2. The method as claimed in claim 1, further comprising validating, by the project maintenance computing device, the relationship model to determine a strength of the relationship model.

3. The method as claimed in claim 1, further comprising automating, by the project maintenance computing device, an update of the software maintenance project repository based on the determined optimal set of project delivery characteristic.

4. The method as claimed in claim 1, wherein the one or more optimization techniques comprise of linear techniques or nonlinear techniques or heuristics techniques.

5. The method as claimed in claim 1, wherein the client portfolio characteristics includes application characteristics, service characteristics, maintainability characteristics or combination thereof.

6. The method as claimed in claim 1, wherein the one or more regression models are multinomial logistic regression model, multiple regression model, or ordinal logistics regression model.

7. A project maintenance computing device comprising:
a processor;
a memory, wherein the memory coupled to the processor which are configured to execute programmed instructions stored in the memory comprising:
obtaining, a plurality of project maintenance characteristics and client portfolio characteristics from a software maintenance project repository;
assigning, a rating to each of the project maintenance characteristics and the client portfolio characteristics based on a one or more assessment guidelines ;
building, a relationship model between the project maintenance characteristics and the client portfolio characteristics by using one or more regression models wherein the relationship model uses an average of the assigned ratings of each of the project maintenance characteristics and the client portfolio characteristics; and
determining, an optimal set of project delivery characteristics based on the built relationship model by using one or more optimization techniques.

8. The device as claimed in claim 7, further comprises validating, the relationship model to determine a strength of the relationship model.

9. The device as claimed in claim 7, further comprises updating, the software maintenance project repository based on the determined optimal set of project delivery characteristic.

10. The device as claimed in claim 7, wherein the one or more optimization techniques comprise of linear techniques or nonlinear techniques or heuristics techniques.

11. The device as claimed in claim 7, wherein the client portfolio characteristics includes application characteristics, service characteristics, maintainability characteristics or combination thereof.

12. The device as claimed in claim 7, wherein the one or more regression models are multinomial logistic regression model, multiple regression model, or ordinal logistics regression model.

13. A non-transitory computer-readable medium storing computer-readable instructions that, when executed by one or more computing devices, cause at least one of the one or more computing devices to:
obtaining, a plurality of project maintenance characteristics and client portfolio characteristics from a software maintenance project repository;
assigning, a rating to each of the project maintenance characteristics and the client portfolio characteristics based on a one or more assessment guidelines ;
building, a relationship model between the project maintenance characteristics and the client portfolio characteristics by using one or more regression models wherein the relationship model uses an average of the assigned ratings of each of the project maintenance characteristics and the client portfolio characteristics; and
determining, an optimal set of project delivery characteristics based on the built relationship model by using one or more optimization techniques.

14. The medium of claim 13, further comprises validating, the relationship model to determine a strength of the relationship model.

15. The medium of claim 13, further comprises updating the software maintenance projects repository based on the determined optimal set of project delivery characteristic.

16. The medium of claim 13, wherein the one or more optimization techniques comprise of linear techniques or nonlinear techniques or heuristics techniques.

17. The medium of claim 13, wherein the client portfolio characteristics includes application characteristics, service characteristics and maintainability characteristics.

18. The medium of claim 13, wherein the one or more regression models are multinomial logistic regression model, multiple regression model, and ordinal logistics regression model.
